(19) United States
(12) Patent Application Publication
(10) Pub. No.: US 2015/0291787 A1
(43) Pub. Date: Oct. 15, 2015

(54) LYOTROPIC LIQUID CRYSTAL TEMPLATED HYDROGELS FOR USE AS FORWARD OSMOSIS DRAW AGENTS

(71) Applicant: University of Iowa Research Foundation, Iowa City, IA (US)

(72) Inventors: C. Allan Guymon, Iowa City, IA (US); Jacob R. McLaughlin, Coralville, IA (US); Nicholas Abbott, Madison, WI (US)

(21) Appl. No.: 14/684,324

(22) Filed: Apr. 10, 2015

Related U.S. Application Data
(60) Provisional application No. 61/978,000, filed on Apr. 10, 2014.

(51) Int. Cl. C08L 33/26; B01D 61/24; C08L 33/06

(52) U.S. Cl. CPC C08L 33/26; C08L 33/064; B01D 61/24

(57) ABSTRACT

Lyotropic liquid crystal-templated compositions that include hydrogels comprising a cross-linked mixture of a stimuli-responsive agent and a super absorbent agent are presented. The compositions are amenable for methods directed to processing and absorbing fluids, including water purification and fluid concentration.

### CROSS-REFERENCE TO RELATED APPLICATIONS

This application claims benefit of priority under 35 U.S.C. 119 to U.S. provisional patent application Ser. No. 61/978,000, filed Apr. 10, 2014, and entitled “Lyotropic Liquid Crystal Templated Hydrogels For Use As Forward Osmosis Draw Agents,” the content of which is herein incorporated by reference in its entirety.

### STATEMENT OF GOVERNMENT INTEREST

This invention was made with government support under CBET-0933450, CBET-1438486, and DMR-1121288 awarded by the National Science Foundation. The government has certain rights in the invention.

### FIELD

The present disclosure relates to methods for making modified hydrogels and their use in fluid purification and concentration.

### BACKGROUND

Several different types of contaminants are present in drinking water supplies, including organic, microbiological, inorganic, and particulate matter. It is well known in the field of water purification that particulate matter can be removed by strainers, fibrous filters, sand beds, granular anthracite packed beds, and diatomaceous earth filters.

Organic compounds present in water systems include hydrocarbons such as humic, fulvic and tannic acids, petroleum products such as oil, gasoline and kerosene, and volatile organic compounds (“VOCs”) such as chloroform, benzene, aldehydes, trichloroethylene, toluene, chloral, chloroethane and vinyl chloride. Other organic compounds include pesticides, herbicides, algaecides, dioxin, phenols, polychlorinated biphenyls (“PCBs”), hydrogen sulfide, alcohols, ammonia and urea.

Organic compounds are currently removed from drinking water by the use of granulated activated carbon (“GAC”) and/or diffused or packed-tower aeration. Although GAC, like other carbonous sorbents, may remove VOCs, it is not effective in removing other harmful contaminants such as hydrogen sulfide and ammonia. It is also well known that activated carbon tends to form densely packed beds, particularly in their finely divided state where they are most efficient. These densely packed beds experience pressure loss, inhibiting the flow of liquid. Thus, it is difficult to utilize GAC in performing continuous filtration of liquid streams. Microbial contaminants also commonly exist in water systems, especially in rural areas, which are without the benefit of chlorination. These contaminants include bacteria, algae, fungi, yeast and viruses. Microbiological contaminants are currently removed with ceramic filters, chemical disinfection or ultraviolet (“UV”) irradiation.

With respect to the removal of microbial contaminants, packed beds of sufficiently small particles are helpful in reducing microbial contamination in water. Cholera, for example, was eradicated in New York in the 1800's in part by the institution of sand bed filters throughout the State. Granular sorbent beds may also remove bacteria and algae from water; however, they are much more conducive to biological colonization than sand because of their irregular, jagged surfaces which provide secure, stagnant crevices for microbe attachment and growth. Further, as a result of their sorption of certain other contaminants such as sulfates and humic acid, the granular sorbent beds may also provide nutrients to the attached microbes. The presence of nutrients fosters the biological growth of the microbes. Microbes, such as anaerobic bacteria, in turn, produce sulfide gases. Therefore, using granulated sorbents alone may increase the biological contamination of the water supply as well as the increase the production of undesirable, noxious sulfide gases. Further, utilizing such a filter system would require an additional disinfecting step such as UV irradiation.

Inorganic contaminants dissolved in water systems include radicals such as chlorine, fluorine, nitrates, sulfates and phosphates as well as metals such as mercury, lead, arsenic, copper, zinc, chromium and iron. Inorganic compounds are usually removed from drinking water through the processes of reverse osmosis, deionization, distillation, electrodialysis, and crystallization (or freezing).

U.S. Pat. No. 4,238,334 to Christopher J. Halbfoster is directed to a filter bed for removing impurities from liquids, such as removing chlorine from an aqueous suspension, comprising a mixture of treated fibrous filter aid material and an active particulate material. The active particulate material is selected from the group consisting of organic polymeric absorbent, zeolite, bentonite, zirconium oxide, zirconium phosphate, activated alumina, ferrous sulfide, activated carbon and diatomaceous earth.

U.S. Pat. No. 4,081,365 to Eugene B. White et al. is directed to a method and an apparatus for the treatment of sewage and waste materials in accordance with a specific process. In the process, a regeneration step may be utilized whereby a tertiary treatment apparatus is reactivated through a wet-oxidation process, employing air and water that has been heated to a desired temperature, the water being supplied from a reservoir and then heated. The sorbent bed is described as containing minerals, such as red flint, on top of which is disposed an adsorption layer comprising a hydraulic mix of activated carbon and quartz.

U.S. Pat. No. 4,661,256 to Russell W. Johnson is directed to the removal of trace quantities of hydrocarbonaceous compounds from an aqueous stream, by adsorbing hydrocarbon impurities onto a regenerable adsorbent. According to the patent, the aqueous stream is contacted with an adsorbent such as a molecular sieve, amorphous silica-alumina gel, activated carbon, activated alumina, silica gel, or clay.

Hydrogels are networks of hydrophilic polymer chains in which water is the dispersion medium. Hydrogels are highly absorbent natural or synthetic polymeric networks. Hydrogels possess a degree of flexibility very similar to natural tissue, due to their significant water content. Some common uses for hydrogels include those having the ability to sense changes of pH, temperature, or the concentration of metabolite and release their load as result of such a change and those displaying the ability to absorb fluids such as water, urine and other fluids.

U.S. Pat. No. 5,178,768 to Donald H. White, Jr. is directed to a mixed filter bed, hydrogel-based composition for purifying water for human consumption, wherein the pre-purified water contains inorganic, organic and biological contaminants. In particular, the mixed filter bed composition includes the following components: (a) from about 40% to about 80% by weight of carbonous sorbent; (b) from about 5% to about 20% by weight of activated alumina; (c) from about 5% to about 20% by weight of silica hydrogel; (d) from about 5% to about 20% by weight of zeolite; and (e) from about 0% to about 10% by weight of metallic components that generate metallic cations. The composition provides potable water free of organic, inorganic and microbial contaminants. The composition also imparts the filtration characteristics of traditional adsorbents while avoiding increased biological contamination of drinking water during the filtration process.

In the context of water desalination as well as hazardous chemical and biological wastewater cleanup, forward osmosis (FO) holds the potential for much lower energy desalination as compared with reverse osmosis. In the FO process, a draw solute of high osmotic pressure (compared to that of the saline water for the desalination process) passes across one side of the membrane, and saline water passes across the other side. Water permeates through the membrane from the saline water to the draw solute side due to the naturally-driven osmotic flow. It is then necessary to regenerate the draw solute and remove the water transferred by the FO process.

Draw agents used in the FO process must have a high osmotic pressure, but should also be able to release their water at a modest energy cost. Several draw agents have been developed, including ammonium carbonate, sugar and ethanol. Li et al. described in Chem. Commun. 47:1710-1712 (2011) the development of fast stimuli-responsive polymer hydrogel particles as a class of draw media. These authors synthesized and evaluated four different types of thermal-chemical cross-linked polymer hydrogels as FO draw agents, including two non-ionic hydrogels: poly(acrylamide) (PAM) and poly(N-isopropylacrylamide) (PNIPAM); and two ionic polymer hydrogels: poly(sodium acrylate) (PSA) and (poly(sodium acrylate)-co-poly(N-isopropyl-acrylamide) (PSA-NIPAM), the latter being prepared with an equimolar amount of N-isopropyl-acrylamide (NIPAM) and sodium acrylate (SA). The FO permeation process was carried out at room temperature and used 2000 ppm NaCl as the feed saline water. The four hydrogels were able to cause the drawing of water through the membrane, wherein the water content of the swollen hydrogels ranged from about 42% to about 73% after 24 hr. The dewatering process is achieved via deswelling of polymer hydrogels with release of water. The water recovery rate for swollen polymer hydrogels with different water contents after dewatering was determined based on hydrostatic pressure at different temperatures, wherein water release was maximal for all swollen hydrogels at elevated temperature (e.g., 50° C.). Li et al. described in Soft Matter, 7:10048-10056 (2011) that the addition of carbon particles to such polymer hydrogels increases the swelling pressure of hydrogels, resulting in the improvement of fluxes in the FO process, particularly with solar heating as the temperature stimulus.

Razmjou et al. described in Chemical Engineering Journal 215-216: 913-920 (2013) the effect of the hydrogel particle size on the performance of FO desalination, wherein four hydrogel samples with particle size ranges of 2-25 μm, 190-350 μm, 350-500 μm, and 500-1000 μm were investigated. The hydrogel swelling rate is inversely proportional to hydrogel particle size, where a reduction in hydrogel particle size resulted in an increase in the rate of swelling. Conversely, higher liquid water recovery rates are achieved for large particles under gas pressure-stimulus, whereas reduced liquid water recovery rate are obtained for small particles under temperature-stimulus.

Razmjou et al. described in Environ. Sci. Technol. 47:6297-6305 (2013) the synthesis of composite hydrogels modified to include magnetic nanoparticles (γ-Fe₂O₃, <50 nm) and their evaluation as FO draw agents in the presence of magnetic heating as the temperature stimulus. Magnetic heating was shown as an effective and rapid method for dewatering of hydrogels by generating the heat more uniformly throughout the draw agent particles, and thus, a dense skin layer commonly formed via conventional heating from the outside of the particle can be minimized.

Forney and Guymon described in Macromol. Rapid Commun. 32:765-769 (2011) the characterization of a nanostructured poly(N-isopropylacrylamide) (PNIPAM) hydrogel synthesized by photopolymerizing N-isopropylacrylamide (NIPAM) in a bicontinuous cubic lyotropic liquid crystal mesophase template formed using the non-ionic surfactant polyoxyethylene cetyl ether (Brij 52) in water. The bicontinuous cubic nanostructure increases the rate and amount of water expelled from PNIPAM for heating above the lower critical solution temperature (LCST) relative to an isotropic PNIPAM hydrogel while maintaining the mechanical integrity of the polymer.

### BRIEF SUMMARY

In a first aspect, a lyotropic liquid crystal-templated composition is provided. The lyotropic liquid crystal-templated composition includes a hydrogel including a cross-linked mixture of a stimuli-responsive agent and a super absorbent agent. The stimuli-responsive agent and the super absorbent agent differ.

In a second aspect, a formulation for preparing a lyotropic liquid crystal-templated composition is provided. The formulation includes the following components: a surfactant; a non-reactive polar solvent; a stimuli-responsive agent; a super absorbent agent; a cross-linking agent; and a photo-initiating agent. The stimuli-responsive agent and the super absorbent agent differ.

In a third aspect, a method of making a lyotropic liquid crystal-templated composition is provided. The method includes several steps. The first step includes preparing a first mixture. The first mixture includes the following components: a surfactant; a non-reactive polar solvent; a stimuli-responsive agent; a super absorbent agent; a cross-linking agent; and a photo-initiating agent. The stimuli-responsive agent and the super absorbent agent differ. The second step includes forming a lyotropic liquid crystal phase in the first mixture to form a second mixture. The lyotropic liquid crystal phase comprises the surfactant and a portion of the non-reactive polar solvent. The third step includes photochemically reacting the second mixture to form a third mixture. The fourth step includes removing the lyotropic liquid crystal phase from the third mixture to yield the lyotropic liquid crystal-templated composition.

In a fourth aspect, a method of processing a fluid is provided. The method includes several steps. The first step includes contacting the fluid with a membrane in fluid communication with a draw agent to form a first system. The draw agent comprises at least one member selected from a group consisting of: a lyotropic liquid crystal-templated composition of the first aspect; a lyotropic liquid crystal-templated composition produced from formulations of the second aspect; and a lyotropic liquid crystal-templated composition produced according to a method of the third aspect; or a combination thereof. The second step includes processing the first system to form a second system. The third step includes recovering a processed fluid from the second system.

In a fifth aspect, a method of absorbing a fluid is provided. The method includes the step of contacting the fluid with a draw agent. The draw agent includes at least one member selected from a group consisting of the following: a lyotropic liquid crystal-templated composition of the first aspect; a lyotropic liquid crystal-templated composition produced from a formulation of the second aspect; and a lyotropic liquid crystal-templated composition produced according to a method of the third aspect; or a combination thereof.

In a sixth aspect, a kit including a draw agent is provided. The draw agent includes at least one member selected from a group consisting of: a lyotropic liquid crystal-templated composition of the first aspect; a lyotropic liquid crystal-templated composition produced from a formulation of the second aspect; and a lyotropic liquid crystal-templated composition produced according to a method of the third aspect; or a combination thereof.

These and other features, objects and advantages of the present invention will become better understood from the description that follows. In the description, reference is made to the accompanying drawings, which form a part hereof and in which there is shown by way of illustration, not limitation, embodiments of the invention.

### BRIEF DESCRIPTION OF THE DRAWINGS

The features, objects and advantages other than those set forth above will become more readily apparent when consideration is given to the detailed description below. Such detailed description makes reference to the following drawings.

FIG. 1 depicts an illustration for the process for preparing lyotropic liquid crystal-templated compositions disclosed herein.

FIG. 2A depicts results of water uptake through a purification membrane for hydrogels prepared from a lyotropic liquid crystal-templated hydrogel composition (green) and an isotropic hydrogel composition (red) prepared using the same materials (that is, poly(N-isopropylacrylamide) (89% (wt/wt))-poly(sodium acrylate) (9% (wt/wt)) hydrogels).

FIG. 2B depicts results of water flux through a purification membrane for hydrogels of FIG. 2A prepared from a lyotropic liquid crystal-templated hydrogel composition (green) and an isotropic hydrogel composition (red) prepared using the same materials (that is, poly(N-isopropylacrylamide) (89% (wt/wt))-poly(sodium acrylate) (9% (wt/wt)) hydrogels).

FIG. 3 depicts results of the effect of water release at two different temperatures (ΔEquilibrium at 22° C. vs. 50° C.) for template-directed hydrogel formation (left panel) vs. isotropic hydrogel formation (right panel) for hydrogels including differing amounts of super absorbent agent (poly(sodium acrylate) (PSA) and containing 65-98% (wt/wt) stimulus-responsive agent (poly(N-isopropylacrylamide) (PNIPAM)).

FIG. 4A depicts the effect of temperature cycling on hydrogel swelling of a templated-material (prepared in aqueous solutions including 45% (wt/wt) Brij 52) for lyotropic liquid crystal-templated compositions containing 78-98% (wt/wt) poly(N-isopropylacrylamide (PNIPAM)) with varying amounts of poly(sodium acrylate) (PSA) when cycled between 22° C. to 50° C. Discs of the hydrogel material were allowed to equilibrate at each temperature for 24 hours. Peak to valley change indicates reversible dynamic range of materials. Key: red inverted triangles, 0% (wt/wt) poly(sodium acrylate); orange squares, 9% (wt/wt) poly(sodium acrylate); blue squares 16% (wt/wt) poly(sodium acrylate); black squares, 20% (wt/wt) poly(sodium acrylate).

FIG. 4B depicts the effect of temperature cycling on hydrogel swelling of an isotropic material, compositions containing 78-98% (wt/wt) poly(N-isopropylacrylamide (PNIPAM)) with varying amounts of poly(sodium acrylate) (PSA) when cycled between 22° C. to 50° C. Discs of the hydrogel material were allowed to equilibrate at each temperature for 24 hours. Peak to valley change indicates reversible dynamic range of materials. Key: red inverted triangles, 0% (wt/wt) poly(sodium acrylate); orange squares, 9% (wt/wt) poly(sodium acrylate); blue squares 16% (wt/wt) poly(sodium acrylate); black squares, 20% (wt/wt) poly(sodium acrylate).

FIG. 5A depicts the kinetics of deswelling for copolymer materials prepared with lyotropic liquid crystal-templated photopolymerization methods disclosed herein with templated hydrogels (prepared in aqueous solutions including 45% (wt/wt) Brij 52). The 78-98% (wt/wt) PNIPAM materials were placed in 50° C. water after equilibrating at 22° C. Swelling ratios were recorded at various time points and discs were allowed to equilibrate at 50° C. Key: red inverted triangles, 0% (wt/wt) poly(sodium acrylate); orange squares, 9% (wt/wt) poly(sodium acrylate); blue squares 16% (wt/wt) poly(sodium acrylate); black squares, 20% (wt/wt) poly(sodium acrylate).

FIG. 5B depicts the kinetics of deswelling for isotropic copolymer materials. The 78-98% (wt/wt) PNIPAM materials were placed in 50° C. water after equilibrating at 22° C. Swelling ratios were recorded at various time points and discs were allowed to equilibrate at 50° C. Key: red inverted triangles, 0% (wt/wt) poly(sodium acrylate); orange squares, 9% (wt/wt) poly(sodium acrylate); blue squares 16% (wt/wt) poly(sodium acrylate); black squares, 20% (wt/wt) poly(sodium acrylate).

FIG. 6 depicts a schematic for a preferred method for processing a fluid with lyotropic liquid crystal-templated compositions disclosed herein.

FIG. 7 depicts a schematic for a preferred method for absorbing a fluid with lyotropic liquid crystal-templated compositions disclosed herein.

While the present invention is amenable to various modifications and alternative forms, exemplary embodiments thereof are shown by way of example in the drawings and are herein described in detail. It should be understood, however, that the description of exemplary embodiments is not intended to limit the invention to the particular forms disclosed, but on the contrary, the intention is to cover all modifications, equivalents and alternatives falling within the spirit and scope of the invention as defined by the embodiments above and the claims below. Reference should therefore be made to the embodiments and claims herein for interpreting the scope of the invention.

### DETAILED DESCRIPTION

The compositions, formulations and methods now will be described more fully hereinafter with reference to the accompanying drawings, in which some, but not all permutations and variations of embodiments of the invention are shown. Indeed, the invention may be embodied in many different forms and should not be construed as limited to the embodiments set forth herein. These embodiments are provided in sufficient written detail to describe and enable one skilled in the art to make and use the invention, along with disclosure of the best mode for practicing the invention, as defined by the claims and equivalents thereof.

Likewise, many modifications and other embodiments of the compositions, formulations and methods described herein will come to mind to one of skill in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

### GLOSSARY OF TERMS AND DEFINITIONS

Terms and definitions are initially presented. Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

Moreover, reference to an element by the indefinite article “a” or “an” does not exclude the possibility that more than one element is present, unless the context clearly requires that there be one and only one element. The indefinite article “a” or “an” thus usually means “at least one.”

As used herein, “about” means within a statistically meaningful range of a value or values such as a stated concentration, length, molecular weight, pH, sequence identity, time frame, temperature or volume. Such a value or range can be within an order of magnitude, typically within 20%, more typically within 10%, and even more typically within 5% of a given value or range. The allowable variation encompassed by “about” will depend upon the particular system under study, and can be readily appreciated by one of skill in the art.

Ranges recited herein include the defined boundary numerical values as well as sub-ranges encompassing any non-recited numerical values within the recited range. For example, a range from about 0.01 mM to about 10.0 mM includes both 0.01 mM and 10.0 mM. Non-recited numerical values within this exemplary recited range also contemplated include, for example, 0.05 mM, 0.10 mM, 0.20 mM, 0.51 mM, 1.0 mM, 1.75 mM, 2.5 mM 5.0 mM, 6.0 mM, 7.5 mM, 8.0 mM, 9.0 mM, and 9.9 mM, among others. Exemplary sub-ranges within this exemplary range include from about 0.01 mM to about 5.0 mM; from about 0.1 mM to about 2.5 mM; and from about 2.0 mM to about 6.0 mM, among others. The same principles apply for ranges describing time, temperature, energy and wavelength, among other variables contemplated herein.

Terms “comprise,” “include” and “have,” as well as verb tense forms of these terms, are open, non-restricted terms, have the same meaning and are used interchangeably throughout the disclosure.

The phrases “templated material,” “templated composition” and “surfactant-templated material,” “surfactant-templated composition,” “lyotropic liquid crystal-templated material,” “templated draw agent,” “templated hydrogel draw agent,” “templated hydrogel” and “lyotropic liquid crystal-templated composition” have the same meaning and are used interchangeably throughout the disclosure. The use of the term “templated” in these phrases, as well as in other instances herein, refers to specifying hydrogel compositions that are formed in the presence of a lyotropic liquid crystal phase.

The terms “non-templated” and “isotropic” have the same meaning and are used interchangeably throughout the disclosure. These terms, as they modify hydrogel compositions, refer to compositions that are not formed in the presence of a lyotropic liquid crystal phase.

The term “substantially,” as it refers to a phase component of a lyotropic liquid crystal phase, means the component represents the predominant phase component, or in some cases majority phase component, of the lyotropic liquid crystal phase.

As used herein, the term “non-reactive,” as the term modifies polar solvent, refers to a polar solvent that does not participate in a chemical reaction or otherwise form part of the hydrogel product having a cross-linked mixture of a stimuli-responsive agent and a super absorbent agent.

As used herein, the terms “phase” and “mesophase” have the same meaning when used in the context of characterizing a lyotropic liquid crystal in a solvent and are used interchangeably throughout the disclosure.

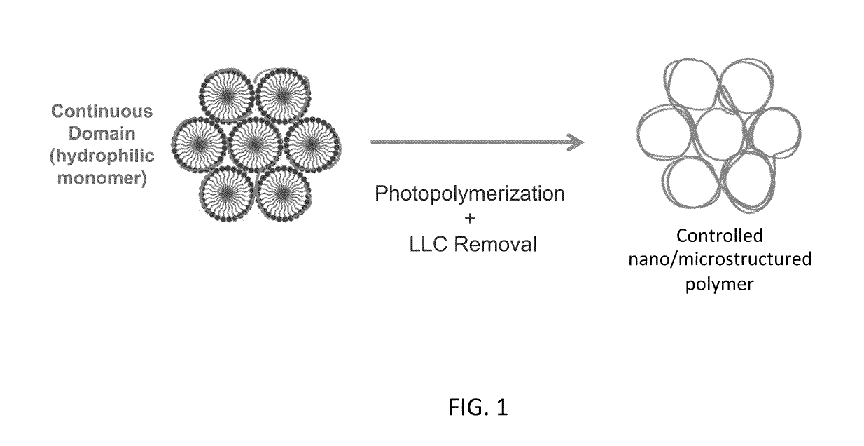

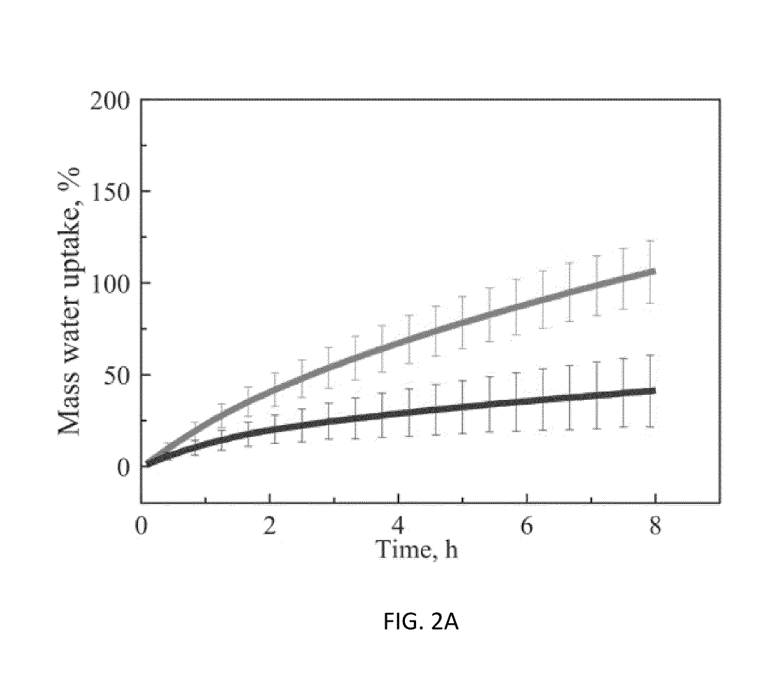

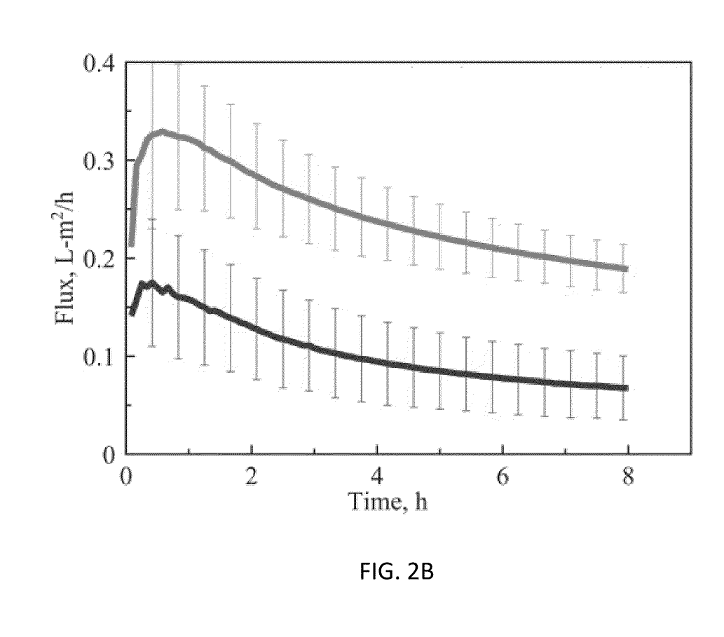

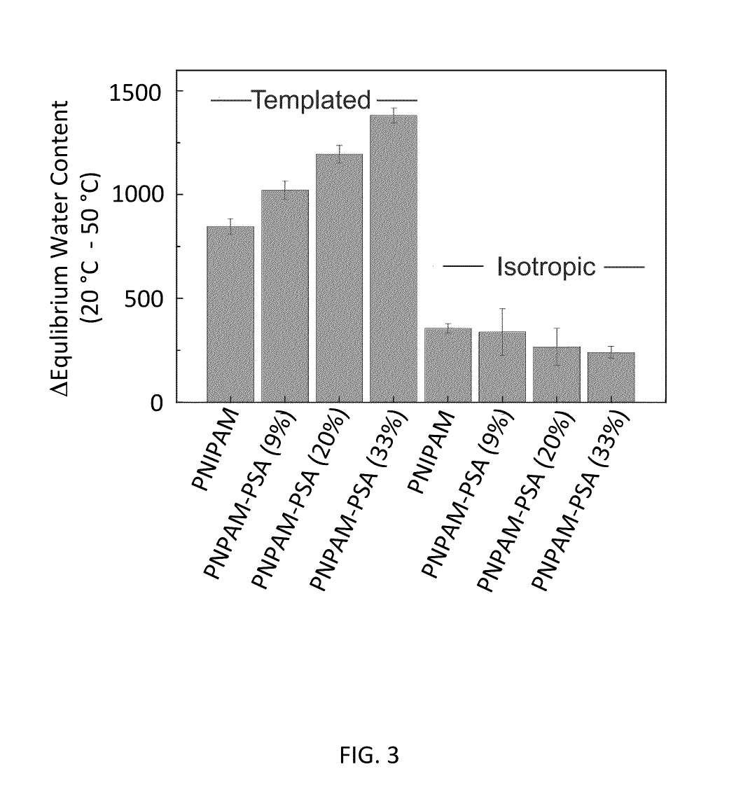

The inventors have discovered novel nanostructured hydrogels synthesized by photopolymerizing a stimuli-responsive agent and a super absorbent agent in a lyotropic liquid crystal mesophase template formed using a surfactant in a non-reactive polar solvent (FIG. 1). The resultant lyotropic liquid crystal-templated compositions display robust swelling and deswelling properties that are tunable by the appropriate stimuli response. In particular, the lyotropic liquid crystal mesophase template endow the resultant hydrogel structures with unexpected and surprising hydrodynamic properties not observed with conventional, isotropic hydrogels that include the same compositional materials (see, for example, FIGS. 2-5).

### Lyotropic Liquid Crystal-Templated Compositions

In a first aspect, a lyotropic liquid crystal-templated composition is provided. The lyotropic liquid crystal-templated composition includes a hydrogel including a cross-linked mixture of a stimuli-responsive agent and a super absorbent agent.

The stimuli-responsive agent and the super absorbent agent include at least one member selected from a group of compounds that include poly(N-isopropylacrylamide) (PNIPAm), Poly(ethylene glycol) diacrylate (PEGDA), poly(ethylene glycol) dimethacrylate (PEGDMA), poly(oligo ethylene glycol) methacrylate (POEGMA), N-ethylacrylamide, N,N-dimethylacrylamide, N,N-diethylacrylamide, other N-substituted acrylamides, poly(sodium acrylate), poly(acrylic acid), poly(vinyl alcohol) (PVA), poly(ethylene maleic anhydride), cross-linked carboxymethylcellulose, polyacrylonitrile and tetraethylene glycol (TEGDA), or a combination thereof.

Preferred stimuli-responsive agents include at least one member selected from a group consisting of poly(N-isopropylacrylamide) (PNIPAm), Poly(ethylene glycol) diacrylate (PEGDA), poly(ethylene glycol) dimethacrylate (PEGDMA), poly(oligo ethylene glycol) methacrylate (POEGMA), N-ethylacrylamide, N,N-dimethylacrylamide, N,N-diethylacrylamide, and other N-substituted acrylamides, or a combination thereof. In many respects, a highly preferred stimuli-responsive agent includes poly(N-isopropylacrylamide) (PNIPAm).

Preferred super absorbent agents include at least one member selected from a group consisting of Poly(ethylene glycol) diacrylate (PEGDA), poly(ethylene glycol) dimethacrylate (PEGDMA), poly(oligo ethylene glycol) methacrylate (POEGMA), poly(sodium acrylate), poly(acrylic acid), poly(vinyl alcohol) (PVA), poly(ethylene maleic anhydride), cross-linked carboxymethylcellulose, and polyacrylonitrile, or a combination thereof. In many respects, a highly preferred super absorbent agent includes poly(sodium acrylate).

In some respects, the stimuli-responsive agent and the super absorbent agent differ. In other respects, the stimuli-responsive agent and the super absorbent agent are the same. In those other respects, the stimuli-responsive agent and the super absorbent agent can be compounds other than poly(N-isopropylacrylamide) (PNIPAm) and/or poly(sodium acrylate). That is, in those lyotropic liquid crystal-templated compositions that include only one compound serving as both the stimuli-responsive agent and the super absorbent agent, poly(N-isopropylacrylamide) (PNIPAm) and poly(sodium acrylate) are excluded from such compositions.

In some respects, the stimuli-responsive agent is present in the composition in a preferred range from about 1% (wt/wt) to about 97% (wt/wt). In other respects, the stimuli-responsive agent is preferably present in the composition at about 82% (wt/wt).

In some respects, the super absorbent agent is present in the composition in a preferred range from about 1% (wt/wt) to about 60% (wt/wt). In other respects, the super absorbent agent is present in the composition at about 16% (wt/wt).

The lyotropic liquid crystal-templated composition includes a hydrogel nanostructure produced from a lyotropic liquid crystal phase. A preferred lyotropic liquid crystal phase includes at least one member selected from a group consisting of discontinuous cubic phase, hexagonal phase, lamellar phase, discontinuous cubic phase, bicontinuous cubic phase, inverse discontinuous cubic phase, and inverse hexagonal phase, or a combination thereof. In some respects, a highly preferred lyotropic liquid crystal phase includes substantially a bicontinuous cubic phase.

Lyotropic liquid crystal phases are well known in the art. Generally, a lyotropic liquid crystal phase form spontaneously from a mixture of a surfactant in a polar solvent. For the purpose of the present lyotropic liquid crystal-templated compositions, a preferred polar solvent includes one that is non-reactive with respect to photochemically-induced polymerization and cross-linking of the stimuli-responsive agent and the super absorbent agent of the hydrogel in the presence of a cross-linking agent and photo-initiating agent. Thus, a preferred polar solvent includes a non-reactive solvent. Exemplary surfactants and non-reactive polar solvents are described below.

### Formulations for Lyotropic Liquid Crystal-Templated Compositions.

In a second aspect, a formulation for preparing a lyotropic liquid crystal-templated composition is provided. The formulation includes the following components: a surfactant; a non-reactive polar solvent; a stimuli-responsive agent; a super absorbent agent; a cross-linking agent; and a photo-initiating agent. In preferred formulations, the stimuli-responsive agent and the super absorbent agent differ.

As explained supra, the surfactant and the non-reactive polar solvent are configured to form a lyotropic liquid crystal phase. Such lyotropic liquid crystal phases can form spontaneously at specific concentrations of surfactant in non-reactive polar solvent. In many respects, the lyotropic liquid crystal phase includes at least one member selected from a group consisting of discontinuous cubic phase, hexagonal phase, lamellar phase, bicontinuous cubic phase, inverse discontinuous cubic phase, and inverse hexagonal phase, or a combination thereof. In many respects, preferred formulations include the lyotropic liquid crystal phase includes substantially a bicontinuous cubic phase. A preferred surfactant includes at least one member selected from a group consisting Brij IC20, L9, L4, L23, C2, C10, C20, S100, S2, S10, S721, S20, O2, O10, O20, CS17, O3, O5, CO20, CO5, CS12, CS20, CS25, CS50, CS6, LT12, LT23, LT3, LT4, S200, S7, Synperonic 10/6, 11/5, 13/10, 13/12, 13/3, 13/5, 13/5k, 13/6, 91/10, 91/19, 91/2.5, 91/5, L11, LF/26, Lf/28, LF/30, LF/40, Dodecyltrimethylammonium bromide (DTAB), Dodecyltrimethylammonium chloride (DTAC), Cetrimonium bromide (CTAB) and Cetrimonium chloride (CTAC), or a combination thereof. Other surfactants suitable for generating lyotropic liquid crystal phases are well known in the art and can be used in a similar fashion herein. In many respects, a highly preferred surfactant includes Brij 52.

In the foregoing formulations, the surfactant ranges preferably from about 10% (wt/wt) to about 90% (wt/wt). In other formulations, the surfactant ranges preferably from about 25% (wt/wt) to about 70% (wt/wt). In other formulations, a highly preferred amount of surfactant is about 45% (wt/wt). In the foregoing formulations, a preferred non-reactive polar solvent includes at least one member selected from a group consisting of water, glycerol, and dimethylsulfoxide (DMSO), or a combination thereof. Other non-reactive polar solvents suitable for these formulations are well known in the art and can be used in a similar fashion herein. In many preferred formulations, the non-reactive polar solvent includes water.

In the foregoing formulations, the stimuli-responsive agent and the super absorbent agent include at least one member selected from a group of compounds that include poly(N-isopropylacrylamide) (PNIPAm), Poly(ethylene glycol) diacrylate (PEGDA), poly(ethylene glycol) dimethacrylate (PEGDMA), poly(oligo ethylene glycol) methacrylate (POEGMA), N-ethylacrylamide, N,N-dimethylacrylamide, N,N-diethylacrylamide, other N-substituted acrylamides, poly(sodium acrylate), poly(acrylic acid), poly(vinyl alcohol) (PVA), poly(ethylene maleic anhydride), cross-linked carboxymethylcellulose, polyacrylonitrile and tetraethylene glycol (TEGDA), or a combination thereof.

In the foregoing formulations, preferred stimuli-responsive agents include at least one member selected from a group consisting of poly(N-isopropylacrylamide) (PNIPAm), Poly(ethylene glycol) diacrylate (PEGDA), poly(ethylene glycol) dimethacrylate (PEGDMA), poly(oligo ethylene glycol) methacrylate (POEGMA), poly(N-ethylacrylamide), poly(N,N-dimethylacrylamide), poly(N,N-diethylacrylamide) and other poly(N-substituted acrylamides), or a combination thereof. In many formulations, a highly preferred stimuli-responsive agent includes poly(N-isopropylacrylamide) (PNIPAm).

In the foregoing formulations, preferred super absorbent agents include at least one member selected from a group consisting of Poly(ethylene glycol) diacrylate (PEGDA), poly(ethylene glycol) dimethacrylate (PEGDMA), poly(oligo ethylene glycol) methacrylate (POEGMA), poly(poly(sodium acrylate)), poly(acrylic acid), poly(vinyl alcohol) (PVA), poly(ethylene maleic anhydride), cross-linked carboxymethylcellulose and polyacrylonitrile, or a combination thereof. In many formulations, a highly preferred super absorbent agent includes poly(sodium acrylate).

In the foregoing formulations, the stimuli-responsive agent and the super absorbent agent differ. In other respects, the stimuli-responsive agent and the super absorbent agent are the same. In those other respects, the stimuli-responsive agent and the super absorbent agent can be compounds other than poly(N-isopropylacrylamide) (PNIPAm) and/or poly(sodium acrylate). That is, in those formulations that include only one compound serving as both the stimuli-responsive agent and the super absorbent agent, poly(N-isopropylacrylamide) (PNIPAm) and poly(sodium acrylate) are excluded from such formulations.

In the foregoing formulations, the stimuli-responsive agent is present in a range from about 1% (wt/wt) to about 87% (wt/wt). In many preferred formulations, the stimuli-responsive agent is present at about 20% (wt/wt).

In the foregoing formulations, the super absorbent agent is present in a range from about 1% (wt/wt) to about 53% (wt/wt). In many preferred formulations, the super absorbent agent is present at about 4% (wt/wt).

In the foregoing formulations, the cross-linking agent includes at least one member selected from a group consisting of methylene bisacrylamide, tetraethylene glycol diacrylate, poly(ethylene glycol diacrylate), diacrylates, diacrylamides, dimethacrylates, dimethacrylamides, or a combination thereof. Other cross-linking agents suitable for these formulations are well known in the art and can be used in a similar fashion herein. A preferred cross-linking agent includes methylene bisacrylamide.

In the foregoing formulations, the cross-linking agent is present in a range from about 0.05% (wt/wt) to about 5% (wt/wt). In some preferred formulations, the cross-linking agent is present at about 0.24% (wt/wt).

In the foregoing formulations, the photo-initiating agent includes at least one member selected from a group consisting of 2,2-dimethoxy-2-phenyl acetophenone, 2-hydroxy-4′-(2-hydroxyethoxy)-2-methylpropiophenone and other photo-initiating agents, or a combination thereof. Other photo-initiating agent suitable for these formulations are well known in the art and can be used in a similar fashion herein. In some preferred formulations, the photo-initiating agent includes 2,2-dimethoxy-2-phenyl acetophenone.

In the foregoing formulations, wherein the photo-initiating agent is present in a range from about 0.05% (wt/wt) to about 5% (wt/wt). In some preferred formulations, the photo-initiating agent is present at about 0.24% (wt/wt).

### Preparation of Lyotropic Liquid Crystal-Templated Compositions.

In a third aspect, a method of making a lyotropic liquid crystal-templated composition is provided. The method includes several steps. The first step includes preparing a first mixture. The first mixture includes the following components: a surfactant; a non-reactive polar solvent; a stimuli-responsive agent; a super absorbent agent; a cross-linking agent; and a photo-initiating agent. In many respects, the stimuli-responsive agent and the super absorbent agent differ. In other respects, as explained surpa and in view of the previously stated provisos, the stimuli-responsive agent and the super absorbent agent can be the same compound.

The second step includes forming a lyotropic liquid crystal phase in the first mixture to form a second mixture. As explained supra, the disclosed surfactants will spontaneously form a lyotropic liquid crystal phase in the non-reactive polar solvent at suitable surfactant concentrations, which are well understood and known in the art. For some lyotropic liquid crystal-templated compositions, however, the ease of preparing such compositions and their robustness can be compromised if components of the first mixture are simultaneously mixed together. In those instances, the first mixture can be prepared in the following manner. The surfactant and non-reactive polar solvent are initially mixed together to form a premixture and the remaining components of the first mixture are added to the resultant premixture to form the second mixture. The lyotropic liquid crystal phase, whether present in the premixture or the second mixture, comprises the surfactant and a portion of the non-reactive polar solvent.

The third step includes photochemically reacting the second mixture to form a third mixture. Photochemical reaction is a preferred method of polymerizing and cross-linking the stimuli-responsive agent and a super absorbent agent to form the hydrogel of the desired product composition. Photoreactions proceed on considerably faster kinetic time scales than other chemical reactions, or at a rate enabling a hydrogel nanostructure to be produced from the lyotropic liquid crystal phase in situ. The photoreaction proceeds along a photopolymerization and cross-linking reaction owing to the presence of the cross-linking agent and the photo-initiating agent. Exemplary cross-linking agents and photo-initiating agents are described supra in exemplary formulations. Exemplary photochemical reaction conditions include reacting the second mixture under temperature conditions in the range from about 5° C. to about 80° C. using energies in the range from about 0.1 mW/cm² to about 30 W/cm² with wavelength light in the range from about 280 nm to about 450 nm for an irradiation time in the range from about 1 sec. to about 60 min. A highly preferred set of conditions include photochemically reacting the second mixture at a temperature of about 15-25° C. with an energy of about 5-15 mW/cm² with about 365 nm wavelength light for 15-25 min.

The fourth step includes removing the lyotropic liquid crystal phase from the third mixture to yield the lyotropic liquid crystal-templated composition. Preferred methods for surfactant removal include washing the third mixture with a solvent. Exemplary solvents for this purpose include ethanol, acetone, water, isopropanol, methyl-ethyl ketone, hexane, among others. Other solvents suitable for surfactant removal are well known in the art and can be used in a similar fashion herein. A highly preferred solvent for surfactant removal includes ethanol. A preferred wash temperature includes a temperature in the range from about 5° C. to about 100° C. A preferred wash time includes a wash time in the range from about 8 hours. to about 120 hours.

In the method, the lyotropic liquid crystal-templated composition can include any of the recited final product compositions included in the disclosure, including obvious equivalents and variations thereof. Likewise, a first mixture of the method can include any of the recited formulations included in the disclosure, including obvious equivalents and variations thereof.

### Fluid Processing.

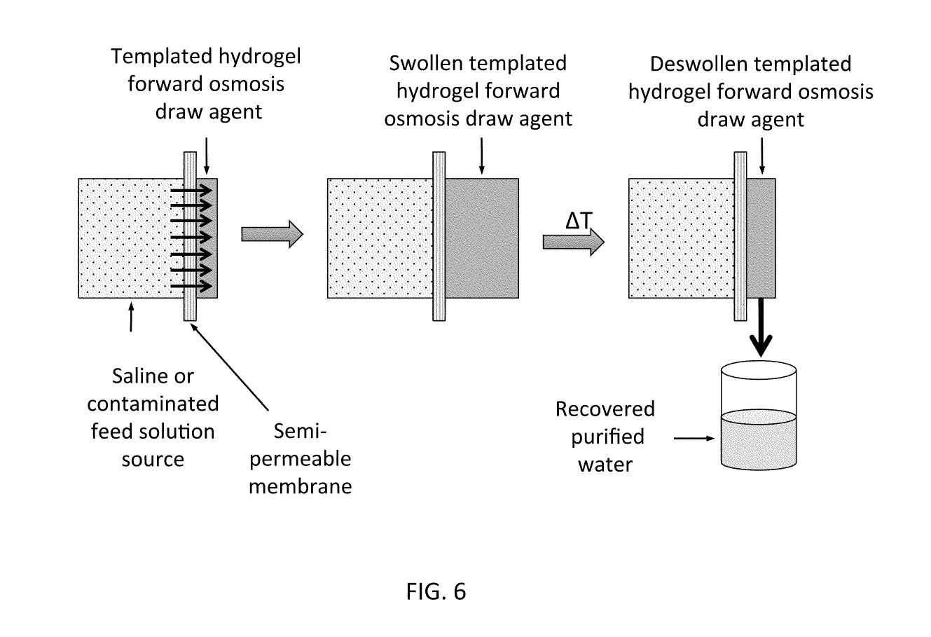

In a fourth aspect, a method of processing a fluid is provided. Referring to FIG. 6, the method includes several steps. The first step includes contacting the fluid with a membrane in fluid communication with a draw agent to form a first system. The draw agent comprises at least one member selected from a group consisting of: a lyotropic liquid crystal-templated composition of the first aspect; a lyotropic liquid crystal-templated composition produced from formulations of the second aspect; and a lyotropic liquid crystal-templated composition produced according to a method of the third aspect; or a combination thereof. In some respects, the membrane includes polyamide, polystyrene, polytetrafluoroethylene, polyethylene, polyester, cellulose acetate, graphene, carbon fiber and ceramic. Other membranes suitable for this purpose are well known in the art and can be used in a similar fashion herein. A highly preferred membrane includes cellulose acetate combined with polyester.

The second step includes processing the first system to form a second system. Suitable processing methods include subjecting the second system to a suitable stimulus response to promote release of the processed fluid from the lyotropic liquid crystal-templated composition, wherein a preferred processing method includes heating as the stimulus response the lyotropic liquid crystal-templated composition. Exemplary temperatures for providing a heat stimulus include temperatures in the range from about 35° C. to about 90° C. In many respects, a highly preferred temperature for providing a heat stimulus includes a temperature of about 50° C.

The third step includes recovering a processed fluid from the second system. In some respects, the step of recovering the processed fluid from the second system includes aspiration, draining and syphoning, among others.

In some respects, the fluid includes a contaminant. In these respects, the contaminant is selected from a group consisting of organic matter, inorganic matter, microbiological material and particulate matter, or a combination thereof. In some respects, the fluid includes a contaminant comprising inorganic matter, such as NaCl or other common inorganic salts.

In other respects, the fluid and the processed fluid include water. In these respects, the fluid includes contaminated water. In some respects, the processed fluid is purified water. In yet other respects, the fluid is a non-concentrated fluid. In these latter respects, the processed fluid is a concentrated fluid.

### Fluid Absorption.

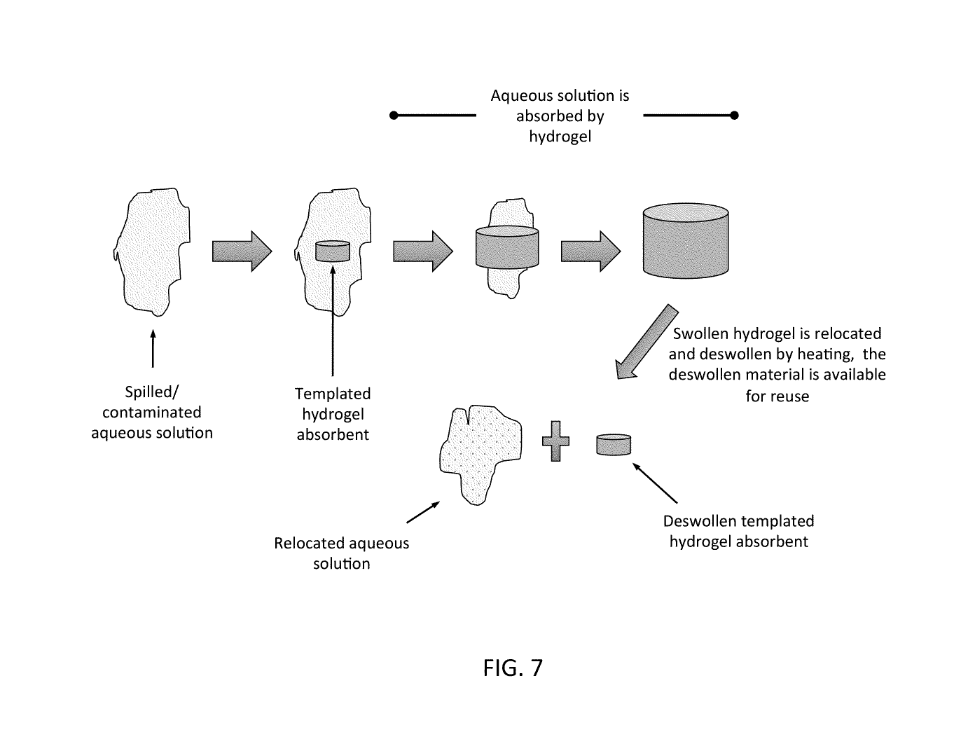

In a fifth aspect, a method of absorbing a fluid is provided. Referring to FIG. 7, the method includes the step of contacting the fluid with a draw agent. The draw agent includes at least one member selected from a group consisting of the following: a lyotropic liquid crystal-templated composition of the first aspect; a lyotropic liquid crystal-templated composition produced from a formulation of the second aspect; and a lyotropic liquid crystal-templated composition produced according to a method of the third aspect; or a combination thereof. Optional subsequent steps include processing the release of the absorbed fluid from the draw agent and recovering the released fluid. In many respects of this method, these additional steps can be accomplished as described supra for methods of processing a fluid.

In some respects, the fluid includes a contaminant. In these respects, the contaminant includes at least one member selected from a group consisting of organic matter, inorganic matter, microbiological material and particulate matter, or a combination thereof.

In some respects, the fluid includes a contaminated water source. In these respects, the contaminated water source includes a chemical hazard, such as an industrial processing chemicals, industrial process waste byproducts, and chemical toxins or poisons. In other respects, the contaminated water source includes a biohazard, such as a pathogenic virus, fungus or bacteria, and biological toxin byproducts produced from the same.

In these respects, the draw agent offers certain advantages over conventional drying agents. The draw agent can be recycled for reuse once the fluid is released from the draw agent. By contrast, most drying agents are irreversibly consumed once they absorb fluids, and such materials are typically disposed of after a single use.

### Kits.

In a sixth aspect, a kit including a draw agent is provided. The draw agent includes at least one member selected from a group consisting of: a lyotropic liquid crystal-templated composition of the first aspect; a lyotropic liquid crystal-templated composition produced from a formulation of the second aspect; and a lyotropic liquid crystal-templated composition produced according to a method of the third aspect; or a combination thereof.

### Applications.

The foregoing lyotropic liquid crystal-templated compositions are amenable for use in aqueous liquid absorption, protein concentration, brine concentration, osmotic power generation, desalination, landfill leachate treatment, juice concentration, municipal or industrial wastewater treatment, oil and gas wastewater treatment, emergency water purification, military water purification, large scale water purification, and other osmosis purification or concentration processes where low energy or low fouling is desired.

### Examples

The invention will be more fully understood upon consideration of the following non-limiting examples, which are offered for purposes of illustration, not limitation.

### Example 1

N-isopropylacrylamide (20% (wt/wt) of total mixture) was mixed with photo-initiating (2,2-dimethoxy-2-phenyl acetophenone, 1% (wt/wt) with respect to total monomer concentration), cross-linker (methylene bisacrylamide, MBA, 1% (wt/wt) with respect to total monomer concentration) and surfactant (Brij 52, 45% (wt/wt) of total mixture). These four components were heated gently and mixed until homogeneous. Sodium acrylate monomer (SA, 2% (wt/wt) of total mixture) was then added to the mixture along with water making up the remainder of the formulation (approximately 23% (wt/wt) of total mixture). The mixture was then heated and mixed to homogeneity. The liquid was poured into molds (12 mm×3 mm discs) and photopolymerized for 20 minutes at 10 mW/cm² using 365 nm UV light. The templated hydrogels were rinsed using an excess of ethanol for at least 24 hours to remove the surfactant and any unreacted monomers, and were then dried.

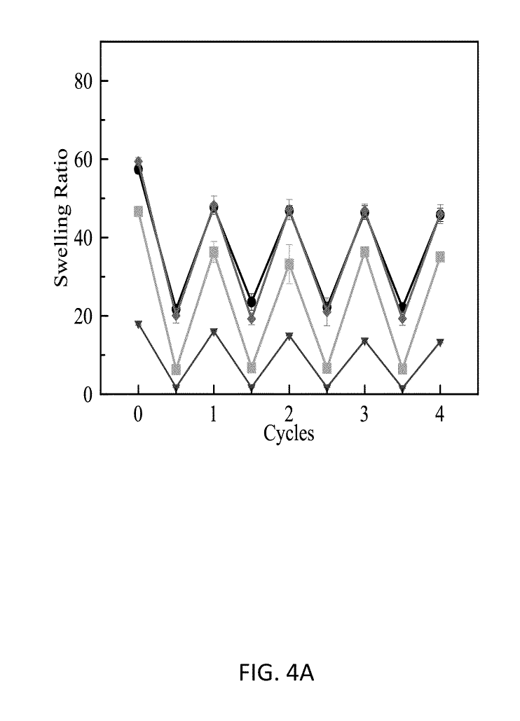

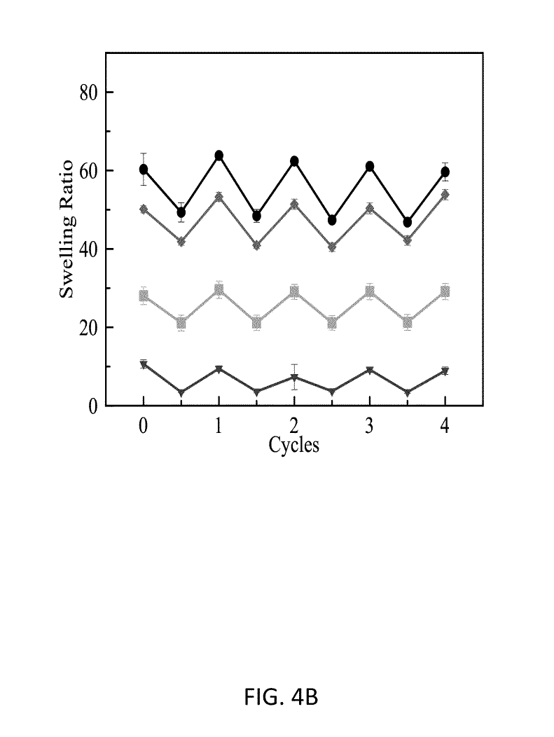

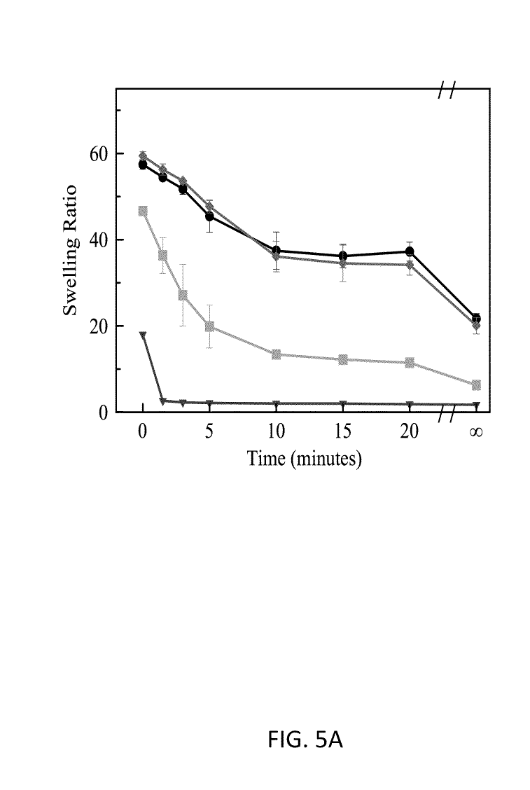

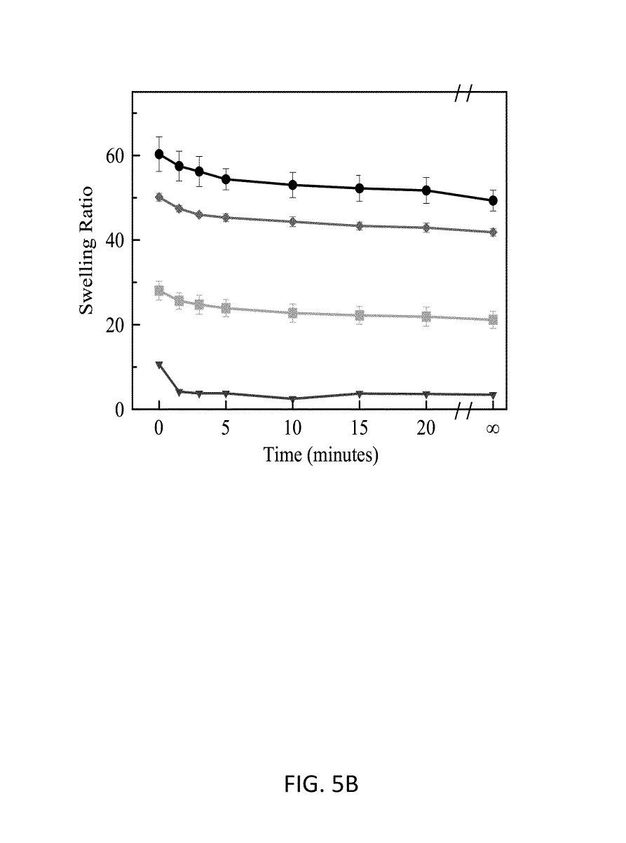

These materials were tested for water flux through a forward osmosis membrane. Powdered hydrogel (250-700 μm) particles were placed on a forward osmosis membrane opposite water. The increase in mass of the material as water was drawn through the membrane into the hydrogel was recorded every five minutes. Both water drawn through membrane as a percentage of polymer powder mass and flux of water through membrane was calculated (FIGS. 4 and 5).

The templated materials made using surfactant-based lyotropic liquid crystals exhibited much greater mass percentage of water absorbed as well as higher rates of water flux across the forward osmosis membrane than materials of identical chemical composition made in the absence of surfactant-based lyotropic liquid crystals (see, for example, FIGS. 2-5).

Materials were also allowed to swell to equilibrium water content and then subjected to deswelling at various temperatures for 24 hours at each time point to measure stimuli-responsive behavior at select temperatures. Templated materials exhibited higher equilibrium swelling and more stimuli-response than non-templated (that is, isotropic) materials of identical chemical composition.

To measure the rate of material stimuli response, materials swollen to equilibrium mass in water were immersed in 50° C. water and the decreasing mass of the swollen material was measured at various time points to record rate of water expulsion and stimuli-response. Compared to isotropic materials (that is, materials not templated by surfactant) of identical chemical composition, the templated materials exhibit higher degrees of equilibrium swelling and are capable of faster and more complete deswelling.

### Example 2

N-isopropylacrylamide (20% (wt/wt) of total mixture) is mixed with photo-initiating (2,2-dimethoxy-2-phenyl acetophenone, 1% (wt/wt) with respect to total monomer concentration), cross-linker methylene bisacrylamide (MBA, 1% (wt/wt) with respect to total monomer concentration) and then heated and mixed to incorporate the three components together. Surfactant (Brij 52, 45% (wt/wt)) was then added to the mixture and heated to a liquid then mixed. Finally sodium acrylate (SA, 4% (wt/wt) of total mixture) was added to the mixture along with water making up the balance. The mixture was heated and mixed to uniformity. The liquid was poured into molds (12 mm×3 mm discs) and photopolymerized for 20 minutes at 10 mW/cm² using 365 nm UV light. The polymerized materials, templated hydrogels, and were rinsed using an excess of ethanol for at least 24 hours to remove the surfactant and any unreacted monomers, and were then dried.

Materials were also allowed to swell to equilibrium water content and then subjected to deswelling at various temperatures for 24 hours at each time point to measure stimuli-responsive behavior at select temperatures. Templated materials exhibited higher equilibrium swelling and more stimuli-response than non-templated materials of identical chemical composition.

To measure the rate of material stimuli response, materials swollen to equilibrium mass in water were immersed in 50° C. water and the decreasing mass of the swollen material was measured at various time points to record rate of water expulsion and stimuli-response. Compared to isotropic (not templated by surfactant) materials of identical chemical composition the templated materials exhibit higher degrees of equilibrium swelling and are capable of faster and more complete deswelling.

### Example 3

Materials were prepared using the same heating, mixing, polymerization, and rinsing procedures as in example 1. N-isopropylacrylamide (20% (wt/wt) of total mixture) is mixed with photo-initiating (2,2-dimethoxy-2-phenyl acetophenone, 1% (wt/wt) with respect to total monomer concentration), cross-linker methylene bisacrylamide (MBA, 1% (wt/wt) with respect to total monomer) and surfactant (Brij 52, 45% (wt/wt) of total mixture). These four components are heated gently and mixed until homogeneous. Super absorbent monomer sodium acrylate (SA, 5% (wt/wt) of total mixture) was then added to the mixture along with water making up the balance.

Materials were also allowed to swell to equilibrium water content and then subjected to deswelling at various temperatures for 24 hours at each time point to measure stimuli-responsive behavior at select temperatures. Templated materials exhibited higher equilibrium swelling and more stimuli-response than non-templated materials of identical chemical composition.

To measure the rate of material stimuli response, materials swollen to equilibrium mass in water were immersed in 50° C. water and the decreasing mass of the swollen material was measured at various time points to record rate of water expulsion and stimuli-response. Compared to isotropic (not templated by surfactant) materials of identical chemical composition the templated materials exhibit higher degrees of equilibrium swelling and are capable of faster and more complete deswelling.

### Example 4

Hydrogel powder from Examples 1, 2, or 3 was placed in a pouch consisting of a forward osmosis membrane on one side and a polyethylene sheet on the other. The pouch is allowed to swell in an aqueous solution. Water was drawn into the hydrogel through the membrane excluding contaminants from the pouch interior via the membrane. Once suitable water has permeated the pouch membrane the pouch is removed from the aqueous solution and heated to above the materials' LCST causing water to be expelled from the hydrogel, the pouch is then opened and the water removed for use. The deswollen hydrogel can then be reused as a draw agent.

### Example 5

### Prophetic

As an example of the methods of the invention: N-isopropylacrylamide (15% (wt/wt)) and N,N-diethyleacrylamide (5% (wt/wt)) is mixed with photo-initiating agent (2-hydroxy-4′-(2-hydroxyethoxy)-2-methylpropiophenone (present at 1% (wt/wt) with respect to total monomer concentration), cross-linker tetra ethylene glycol diacrylate (TEGDA, 0.5% (wt/wt) with respect to total monomer) and surfactant mixture (Brij S10, 20% (wt/wt), Brij S2, 20% (wt/wt)). These five components are heated gently and mixed until homogeneous. Super absorbent monomer sodium acrylate (SA, 6% (wt/wt) total mixture) is then added to the mixture along with water making up the balance. The mixture is then heated and mixed to homogeneity. The liquid is poured into molds (12 mm×3 mm discs) and photopolymerized for 15 minutes at 15 mW/cm² using UV light. The polymerized materials are now templated hydrogels and are rinsed using an excess of ethanol for at least 24 hours to remove the surfactant and any unreacted monomers, and were then dried. These templated materials will exhibit higher water absorbent properties than non-surfactant templated materials and will retain stimuli-responsive behavior more completely.

### Example 6

### Prophetic

A device using templated hydrogel draw agents for continuous or quasi-continuous purification of water using forward osmosis membranes can be constructed. See Cai, Y., Shen, W., Loo, S. L., Krantz, W. B., Wang, R., Fane, A. G., & Hu, X. (2013). Towards temperature driven forward osmosis desalination using Semi-IPN hydrogels as reversible draw agents. Water Research, 47(11), 3773-81. doi:10.1016/j.watres.2013.04.034.

### Example 7

### Prophetic

A fruit juice is placed opposite a templated material from Example 1, 2, or 3 across water permeable membrane that will exclude solutes in the liquid. Via osmotic pressure difference the templated material will draw water from the liquid, reducing its water content and concentrating the liquid for either easier transport or packaging. The templated draw agent will then be heated and the water released. The draw agent can then be reused to further concentrate more juice. This process could be done batch wise, quasi-continuously or continuously.

### Example 8

### Prophetic

Liquid industrial waste water such as is generated during the drilling of oil and gas wells is placed opposite a templated material from Example 1, 2, or 3 across water permeable membrane that will exclude contaminants or solutes in the liquid. Via osmotic pressure difference the templated material will draw water from the liquid, reducing its water content and concentrating the liquid for either easier transport, disposal or packaging. This waste liquid constitutes a health hazard and the reduction in volume by dehydration allows for easier and more economical transport and disposal. The templated draw agent will then be heated and the water released. The draw agent can then be reused to further concentrate more liquid. This process could be done batch wise, quasi-continuously or continuously.

### Example 9

### Prophetic

Land fill leachate, which poses both a biohazard as well as a chemical hazard, is exposed to a semi-permeable membrane with a templated draw agent opposite. The membrane will exclude contaminants and microbes from the draw side of the membrane. Via osmotic pressure the templated material will draw water from the liquid reducing its water content and concentrating the liquid for easier transport, disposal or packaging. The reduction in volume by dehydration allows for easier and more economical transport and disposal. The templated draw agent will then be heated and the remediated water released. The draw agent can then be reused to further concentrate more liquid. This process could be done batch wise, quasi-continuously or continuously.

### Example 10

### Prophetic

A templated hydrogel is placed on a spilled aqueous solution. The liquid and its contents will be drawn into the hydrogel. The now semi-solid hydrated hydrogel mixture will be transferred to an area for regeneration and disposal of the spilled liquid. The hydrogel will be heated to induce water release and then reused in the deswollen state or allowed to dry for additional cycles of liquid clean up.

### INCORPORATION BY REFERENCE

All of the patents, patent applications, patent application publications and other publications recited herein are hereby incorporated by reference as if set forth in their entirety.

The present invention has been described in connection with what are presently considered to be the most practical and preferred embodiments. However, the invention has been presented by way of illustration and is not intended to be limited to the disclosed embodiments. Accordingly, one of skill in the art will realize that the invention is intended to encompass all modifications and alternative arrangements within the spirit and scope of the invention as set forth in the appended claims.

1. A lyotropic liquid crystal-templated composition comprising:
a hydrogel comprising a cross-linked mixture of a stimuli-responsive agent and a super absorbent agent,
wherein the stimuli-responsive agent and the super absorbent agent differ.

2. The lyotropic liquid crystal-templated composition of claim 1, wherein the stimuli-responsive agent comprises at least one member selected from a group consisting of poly(N-isopropylacrylamide) (PNIPAm), Poly(ethylene glycol) diacrylate (PEGDA), poly(ethylene glycol) dimethacrylate (PEGDMA), poly(oligo ethylene glycol) methacrylate (POEGMA), poly(N-ethylacrylamide), poly(N,N-dimethylacrylamide) and poly(N,N-diethylacrylamide), or a combination thereof.

3. The lyotropic liquid crystal-templated composition of claim 1, wherein the stimuli-responsive agent is present in a range from about 50% (wt/wt) to about 95% (wt/wt).

4. The lyotropic liquid crystal-templated composition of claim 1, wherein the stimuli-responsive agent is present at about 82% (wt/wt).

5. The lyotropic liquid crystal-templated composition of claim 1, wherein the stimuli-responsive agent comprises poly(N-isopropylacrylamide) (PNIPAm).

6. The lyotropic liquid crystal-templated composition of claim 5, wherein the poly(N-isopropylacrylamide) (PNIPAm) is present at about 82% (wt/wt).

7. The lyotropic liquid crystal-templated composition of claim 1, wherein the super absorbent agent comprises at least one member selected from a group consisting of Poly(ethylene glycol) diacrylate (PEGDA), poly(ethylene glycol) dimethacrylate (PEGDMA), poly(oligo ethylene glycol) methacrylate (POEGMA), poly(sodium acrylate), poly(acrylic acid), poly(vinyl alcohol) (PVA), poly(ethylene maleic anhydride), cross-linked carboxymethylcellulose, and polyacrylonitrile or a combination thereof.

8. The lyotropic liquid crystal-templated composition of claim 1, wherein the super absorbent agent is present in a range from about 4% (wt/wt) to about 50% (wt/wt).

9. The lyotropic liquid crystal-templated composition of claim 1, wherein the super absorbent agent is present at about 16% (wt/wt).

10. The lyotropic liquid crystal-templated composition of claim 1, wherein the super absorbent agent comprises poly(sodium acrylate).

11. The lyotropic liquid crystal-templated composition of claim 10, wherein the poly(sodium acrylate) is present at about 16% (wt/wt).

12. The lyotropic liquid crystal-templated composition of claim 1, wherein the lyotropic liquid crystal-templated composition comprises a hydrogel nanostructure produced from a lyotropic liquid crystal phase comprises at least one member selected from a group consisting of hexagonal phase, lamellar phase, discontinuous cubic phase and bicontinuous cubic phase, inverse discontinuous cubic phase, and inverse hexagonal phase, or a combination thereof.

13. The lyotropic liquid crystal-templated composition of claim 1, wherein the lyotropic liquid crystal phase comprises substantially a bicontinuous cubic phase.

14. A formulation for preparing a lyotropic liquid crystal-templated composition, comprising:
a surfactant;
a non-reactive polar solvent;
a stimuli-responsive agent;
a super absorbent agent;
a cross-linking agent; and
a photo-initiating agent,
wherein the stimuli-responsive agent and the super absorbent agent differ.

15. The formulation of claim 14, wherein the surfactant and the non-reactive polar solvent are configured to form a lyotropic liquid crystal phase.

16. The formulation of claim 15, wherein the lyotropic liquid crystal phase comprises at least one member selected from a group consisting of hexagonal phase, lamellar phase, discontinuous cubic phase, inverse hexagonal phase, inverse discontinuous cubic phase, and bicontinuous cubic phase, or a combination thereof.

17-40. (canceled)

41. A method of making a lyotropic liquid crystal-templated composition, comprising:
preparing a first mixture comprising:
a surfactant;
a non-reactive polar solvent;
a stimuli-responsive agent;
a super absorbent agent;
a cross-linking agent; and
a photo-initiating agent,
wherein the stimuli-responsive agent and the super absorbent agent differ;
forming a lyotropic liquid crystal phase in the first mixture to form a second mixture,
wherein the lyotropic liquid crystal phase comprises the surfactant and a portion of the non-reactive polar solvent;
photochemically reacting the second mixture to form a third mixture; and
removing the lyotropic liquid crystal phase from the third mixture to yield the lyotropic liquid crystal-templated composition.

42-43. (canceled)

44. A method of processing a fluid, comprising:
contacting the fluid with a membrane in fluid communication with a draw agent to form a first system, wherein the draw agent comprises
a lyotropic liquid crystal-templated composition of claim 1;
processing the first system to form a second system; and
recovering a processed fluid from the second system.

45-54. (canceled)

55. A method of absorbing a fluid, comprising:
contacting the fluid with a draw agent, wherein the draw agent comprises
a lyotropic liquid crystal-templated composition of claim 1.

56-60. (canceled)

61. A kit comprising a draw agent, wherein the draw agent comprises
a lyotropic liquid crystal-templated composition of claim 1.
